(19) United States
(12) Patent Application Publication
(10) Pub. No.: US 2004/0018392 A1
(43) Pub. Date: Jan. 29, 2004

(54) Method of increasing mechanical properties of semiconductor substrates

(75) Inventor: Karl J. Yoder, Denison, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/206,005

(22) Filed: Jul. 26, 2002

(51) Int. Cl. B32B 9/00

(52) U.S. Cl. 428/698; 428/336; 428/701; 257/77; 427/126.1

(57) ABSTRACT

Semiconductor wafers exhibiting increased mechanical strength and reduced susceptibility to fracture and methods of making the same are disclosed. The improved mechanical strength arises from a thin coating of a refractory material deposited on the backside of the wafer. Preferably, the coating is comprised of a ceramic. More preferably, the coating is comprised of silicon carbide. Also disclosed are methods for evaluating different coating materials.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to semiconductor processing. More particularly, the invention relates to techniques for improving mechanical properties of semiconductor substrate materials.

2. Background Information

The ubiquitous presence of semiconductors in almost every electronic device is testament to their importance in today's society. The benefit of using semiconductors in electronic devices is that semiconductor manufacturing undergoes a reduction in the overall feature size of the integrated devices (commonly known as a “process shrink” ) approximately every 18 months. This affords reducing the cost of semiconductor devices, as well as increasing the potential functionality that semiconductors are able to provide because more devices may now be packed into the same area. Semiconductor companies are able to profit from these process shrinks by providing cheaper and better products to their customers.

Semiconductor devices are integrated or built vertically with respect to a substrate, called a “wafer,” in a similar fashion to building a house upon a foundation. The building of semiconductor devices on a wafer involves a series of processing steps (e.g., oxidation, epitaxy, implant, photolithography, deposition, multiprobe, etc.). This processing is done in very costly semiconductor fabrication facilities, called “fabs,” where each step required to manufacture the semiconductor device involves complex and expensive equipment. Hence, semiconductor companies have a great interest in capitalizing the cost of this equipment by running the fabs continuously, and also by maximizing yield, which can be measured as the total number of functional semiconductor devices with respect to the total number wafers ran through the fab.

While the overall yield of a fab may be affected by many factors, the physical handling of wafers at various processing steps by both machines and humans presents mechanical stresses that sometimes cause the wafers to fracture, thereby decreasing the overall yield. This problem is only worsened by the fact that the wafers are cut from a single ingot into very thin slices (e.g., 400 μm to 700 μm in thickness), which makes them easier to fracture. In addition, the starting ingot and subsequent slices are purposefully composed of rigid crystalline structures due to semiconductor device physics; all of this results in wafers that are very brittle.

The wafers could be sliced from the ingot in thicker slices so that they are less apt to break under mechanical stress. However, their crystalline nature would still render them brittle, and making the wafers thicker would have the negative effect of driving up their cost, and it would also make it harder to dice wafers up after processing is complete. There are a limited number of techniques that attempt to address the problem of fracturing the wafers. For example, U.S. Pat. No. 5,110,764 to Ogino discloses beveling the edges of the wafer to reduce the risk of chipping the edges of the wafer. However, beveling the edges of the wafer is only helpful in reducing chipping and other mechanical stress events presented at the edge of the wafer, and as such, mechanical stress imposed on the front side or the back side of the wafer may still fracture the wafer. In addition, established material strengthening schemes for metallic and ceramic materials do not apply to semiconductor wafers because such schemes involve structural modification, and any modification of the wafer's crystalline structure would affect the operation of the electrical devices (i.e., transistors, diodes, resistors, etc.) integrated thereupon. Accordingly, a need exists for increasing mechanical strength of semiconductor wafers.

### BRIEF SUMMARY OF THE PREFERRED EMBODIMENTS OF THE INVENTION

The problems noted above are in large part addressed by coating the wafer with a thin film or coating. In one embodiment the backside of the wafer is coated with a ceramic coating to increase the mechanical properties of the wafer. This particular coating is preferably a thin film that is traditionally used in semiconductor processing so that qualification is not necessary, but the coating may be any material that will increase the mechanical properties of the wafer. Since the coating will undergo the processing steps of semiconductor fabrication, it is desired that the coating be resistant to chemical etching. In addition, it may also be desirable for the coating material to be capable of withstanding high temperatures (e.g., 1000° C.). For example, the coating may be a ceramic coating such as silicon carbide. In an alternate embodiment, silicon dioxide is use as the coating. In yet another embodiment, silicon nitride is used as the coating. In addition, the coating may be removed prior to dicing the wafer into separate integrated circuits.

In another embodiment, a method for determining the most preferred coating selection is disclosed where measurements of the mechanical strength of the non-coated wafers are made. The mechanical strengthening properties of various coatings may then be determined prior to applying the coating to the wafers, or alternately after the wafers have been coated. After the wafer has been coated, the wafer's mechanical strength is tested. The coatings are preferably chosen from a list of coatings commonly used in semiconductor manufacturing and may be limited to coatings with superior adhesion properties. It is preferred that the coatings comprise coatings that can withstand chemical etching, such as silicon carbide. After the coated wafer is tested, a correlation may also be drawn between the mechanical strengthening properties of the coating and the overall mechanical strength of the coated wafer.

### BRIEF DESCRIPTION OF THE DRAWINGS

For a detailed description of the preferred embodiments of the invention, reference will now be made to the accompanying drawings, wherein like parts throughout the drawings are marked with the same reference numerals:

FIG. 1 shows the formation of the ingot;

FIG. 2A shows the ingot and the separation of wafers;

FIG. 2B shows the frontside and backside of a wafer;

FIG. 3 shows a schematic representation of a four-point bend test apparatus;

FIG. 4 shows a wafer with a coating on the backside;

FIG. 5 shows the measured thickness of various coatings;

FIG. 6 shows a table of measured film stress;

FIG. 7 shows modulus of rupture (MOR) data for coated wafers; and

FIG. 8 shows the percent gain in MOR from the coating.

### NOTATION AND NOMENCLATURE

Certain terms are used throughout the following description and claims to refer to particular system components. As one skilled in the art will appreciate, semiconductor companies may refer to processes, components, and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical or wireless connection. Thus, if a first device couples to a second device, that connection may be through a direct electrical connection, or through an indirect electrical or wireless connection via other devices and connections. The terms “substrate,” “semiconductor wafer,” and “wafer” are used synonymously herein, and refer to a disc cut from a semiconductor ingot, where the ingot may comprise any semiconducting element or compound. To the extent that any term is not specially defined in this specification, the intent is that the term is to be given its plain and ordinary meaning.

### DETAILED DESCRIPTION OF THE PREFERRED EMBODIMENTS

Prior to delving into the preferred embodiments of the present invention, it is helpful to give a cursory review of semiconductor wafer manufacturing and processing, and material strengthening and testing techniques. A more detailed presentation of related concepts can be found in “Influence of Design and Coatings on the Mechanical Reliability of Semiconductor Wafers,” by Karl J. Yoder, and “Principles of CMOS VLSI Design,” pp. 109-172, by Neil H. E. West et al. Both of these references are hereby incorporated by reference.

Semiconductor Wafer Manufacturing and Processing

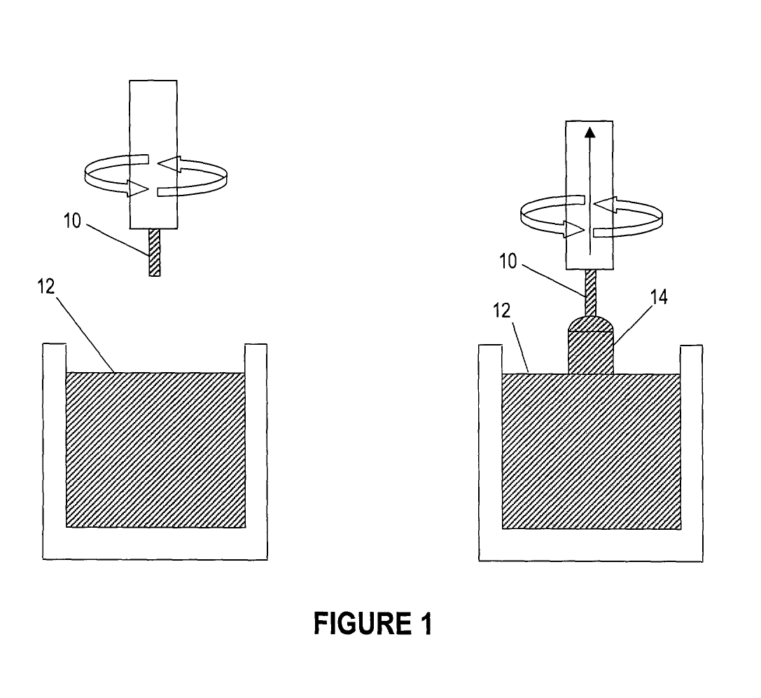

Wafers are preferably grown in a single crystal ingot from a melt by a pulling method (Czochralski or Teal-Little) as seen in FIG. 1. A crystal seed 10 is dipped into a melt 12 and is slowly rotated. Note that the crystal seed 10 and the melt 12 usually comprise the same materials. By controlling the temperature of the melt and/or the amount of heat removed from the seed; freezing onto the seed, or growth is possible. This growth results in a final ingot 14. Seed diameters are typically in the range of a few millimeters, but the final ingot diameter may exceed 300 mm. Controlling the diameter required for crystal growth is accomplished by varying the melt temperature, seed crystal spin rate, and seed pull rate.

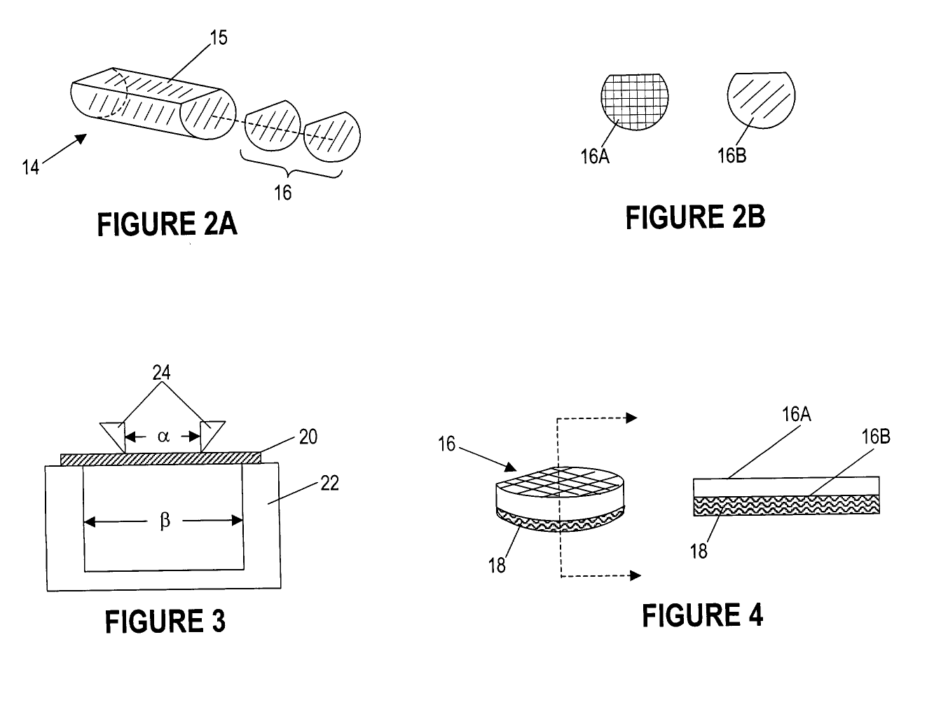

Once the crystal has been pulled and the ingot 14 is formed, the ingot 14 is taken through various mechanical shaping operations to produce symmetrical wafer slices. FIG. 2A shows the ingot 14 with a notch 15, with the ingot 14 is sliced into wafers 16. The wafers 16 have a front side 16A where the semiconductor devices are fabricated, and a backside 16B as shown in FIG. 2B.

It should be noted that great care is taken in producing the crystalline structure of the wafers because it serves as the basis of operation of all semiconducting devices integrated thereon; thus, the crystalline nature of the wafer is deliberate and required.

Wafer fabrication processing may include many process steps, such as: surface cleaning, epitaxy, oxidation, diffusion/implantation, photolithography, etching, layer deposition, multiprobe, and backgrinding. These steps often involve reactive chemicals such as hydrofluoric acid, which is particularly useful in etching oxides and nitrides but has little effect on carbides as will be discussed below. Furthermore, various manufacturers supply the equipment used in wafer production, and there is no standard on how the equipment interfaces with the wafer. As such, a large variety of handling systems are used that have little in common with each other except that they all handle the wafer. Thus, it is important that the wafer be designed to withstand the fabrication process in order support high yield and profitability.

Note that semiconductor ingots may comprise various compounds as would be familiar to one of ordinary skill in the art. Common examples are silicon, gallium arsenide, and indium phosphide to name just a few. As such, although the following discussion centers around wafers made of silicon, it is believed that the following principles may equally apply to wafers made from other compounds (i.e., elements from column IV of the periodic table of elements as well as combinations of elements from columns III-V).

Material Strengthening and Testing

When an external load is applied to a material, the material deforms due to differences in the atomic spacing between the materials. Stress σ is the term used for the external load and is usually given in units of pressure. The subsequent deformation or strain ε is defined as a percent equal to the change in length over the initial length.

The strain a material exhibits depends on a number of factors: atomic bond strength, stress, and temperature. Elastic deformation refers to reversible strain, or the ability of a material to return to its original state when the stress is removed. Equation (1) defines the relationship for tensile stress, where E is Young's modulus.

σ=Eε (1)

For shear loading, Equation (2) defines the stress-strain relationship where τ is the shear stress, γ is the shear strain, and G is the shear modulus.

τ=Gγ (2)

Most ceramics exhibit brittle fracture, where the material behaves elastically with no plastic deformation up to fracture at low temperatures. Additionally, many high purity crystals (e.g., semiconductor substrates) behave in this manner unless there is a suitable method for stress relief, such as purposefully generating dislocations. Otherwise, a crack front will propagate along a crystal plane with relative ease when there is no means to relieve the stress.

Brittle materials (such as ceramics and semiconductor substrates) are commonly tested using bend strength tests. For bending tests, the sample is supported at each end, and a load is applied at either one central point (three-point bending) or two points (four-point bending). FIG. 3 shows a four-point bending arrangement and will be described in detail below. The bend strength is defined by the modulus of rupture (MOR), or the maximum tensile stress at material failure. Equation (3) gives the bend strength of a rectangular structure where M is the moment, c is the distance from the neutral axis to the tensile surface, and I is the moment of inertia. For a rectangular sample, I=bd³/12 and c=d/2 where d is the thickness of the sample and b is the width.

$$S = \frac{M c}{I} \qquad ( 3 )$$

Referring now to FIG. 4, a semiconductor wafer 16 is shown in accordance with a preferred embodiment of the present invention. The wafer 16 is preferably a silicon wafer coated with a thin film 18 on the backside 16B of the wafer. The film 18 is preferably ceramic, but other embodiments may include non-ceramic films as well. Several different types of ceramic coatings (e.g., silicon dioxide, silicon nitride, and silicon carbide) were tested all having a nominal thickness of about 1 μm. It should be noted that both wafers and ceramic coatings can be quite brittle and using a brittle ceramic coating to strengthen a brittle wafer may seem contradictory.

In order to understand this seemingly contradictory practice, consider traditional mechanical strengthening schemes from non-semiconductor applications. A traditional mechanical strengthening scheme involves mixing additional materials (e.g., whisker-like fibers) into a bulk material. In this manner, the additional material serves to distribute the mechanical stress through the bulk material, and also serves to distribute propagating fractures along the length of the fibers. To further this concept, the whisker-like fibers may be pre-tensioned to give more support and possibly close the fracture. However, traditional mechanical strengthening techniques do not apply to semiconductor wafers because mixing any additional material with the wafer would alter the deliberate crystalline structure of the wafer rendering it useless for building semiconductor devices on.

On the other hand, coating the backside of the wafer with a pre-stressed ceramic film provides similar benefits without compromising the crystalline nature of the wafer. The result is that although the wafer and the ceramic are both brittle, the wafer is more brittle than most ceramics. Thus, it is possible to select a ceramic film that will enhance the mechanical strength of the wafer so that any force that would normally cause a fracture now must overcome the residual stress of the film. One main concern in selecting a strengthening material is that the material selected must not affect the mechanical or electrical properties of the wafer in an adverse way. Accordingly, several different ceramic materials that are commonly used in semiconductor processing were tested and are detailed below. Note that the testing described below was not an exhaustive search for all the possible materials, but rather an analysis of materials common to semiconductor processing. As such, one of ordinary skill in the art will recognize that other viable coatings exist that fall within the scope and spirit of this disclosure.

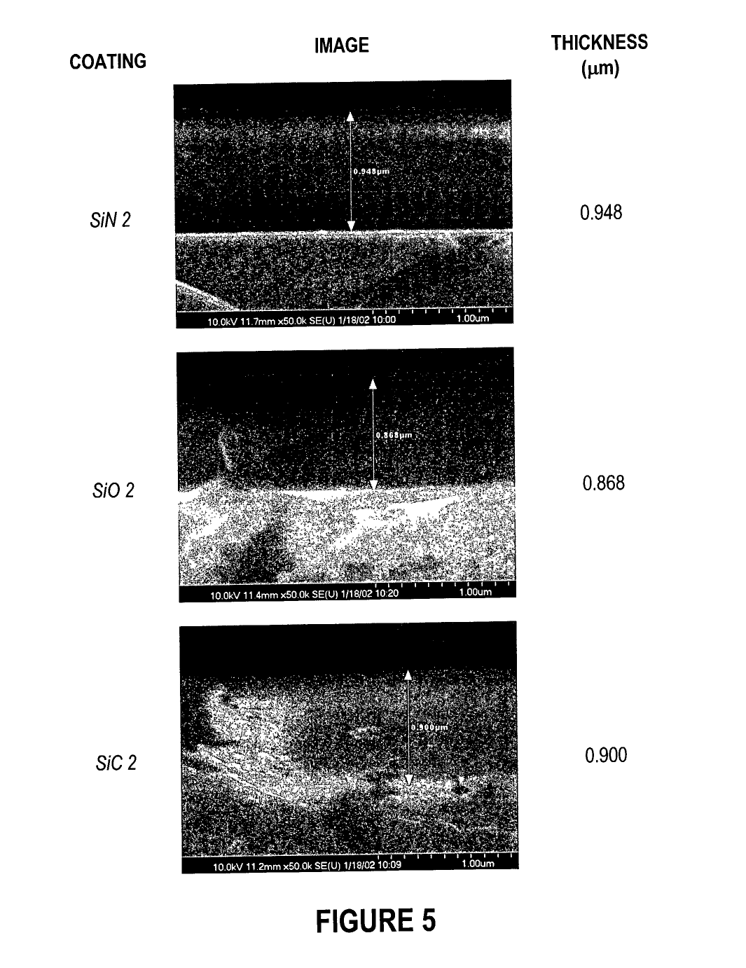

Silicon dioxide (SiO₂) is inherently a very brittle material that may be used as a ceramic thin film. Despite its inherent brittleness, it is possible to increase the mechanical strength of SiO₂ by inducing compressive stress in the surface layer of the material (which is where most material failures occur) using methods such as thermal tempering as well as other chemical methods. Silicon nitride (Si₃N₄) may also be used as a ceramic thin film. The methods of producing silicon nitride include nitriding and plasma-enhanced chemical vapor deposition (PECVD). Nitriding involves the high temperature nitridation of the silicon surface. PECVD is created through the relatively low temperature reaction of silane based compounds with suitable hydrocarbons while in the presence of a RF field. Possible schemes of depositing silicon dioxide and silicon nitride may be found in “Plasma-Deposited Passivation Layers for Moisture and Water Protection,” Surface and Coatings Technology, vol. 74-75 (1995), pp. 676-681, which is incorporated herein by reference. In addition, silicon carbide (SiC) is a widely used non-oxide ceramic that may be used as a thin film ceramic. The form of SiC that is used in semiconductor manufacturing is produced by a PECVD reaction of silane based compounds with suitable hydrocarbons. A method of depositing SiC is outlined in “PECVD Silicon Carbide as a Chemically Resistant Material for Micromachined Transducers,” Sensors and Actuators, vol. A 70 (1998), pp. 48-55, which is incorporated herein by reference. The films were measured using a Hitachi S-4700 scanning electron microscope, with the film thickness ranging between 0.85 μm and 0.951 μm as shown in FIG. 5. It should be noted that while the range measured in FIG. 5 is between 0.85 μm and 0.95 μm, a preferred range is preferably from 0.5 μm to 5 μm.

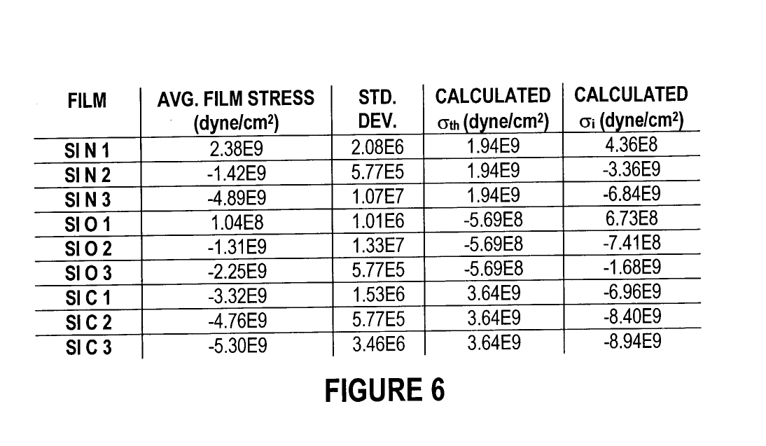

Each of these films were coated on silicon wafers, and then the strength of the wafers was tested using a four-point test rig as shown in FIG. 3. Referring now to FIG. 3, a sample wafer 20 is shown supported by a stand 22, with a two-point stylus 24 applying a downward force. The two edges of the stand 22 were separated by a distance β and the two points of the stylus 24 were separated by a distance α. Samples of each ceramic film type were tested using the four-point test rig arrangement of FIG. 3, with β equal to 10 cm and α equal to 5 cm. The residual stress σᵣ of each coating was measured using an SMSi 9000WM stress measurement system. The instrument determines the bow in the wafer before and after it is coated with the ceramic film using Equation (4) (Stoney's equation):

$${σ}_{r} = \frac{{Et}_{s}^{2}}{6 ( 1 - v ) t} ( \frac{1}{{R}_{f}} - \frac{1}{{R}_{o}} ) \qquad ( 4 )$$

where E is the Young's modulus of the substrate, v is Poisson's ratio of the substrate, tₛ is the thickness of the substrate, t is the thickness of the film, and Rₒ and R_{f} are the initial and final radii of curvature, respectively, of the wafer before and after it is coated with the ceramic film. FIG. 6 shows the measured residual film stress σᵣ of three samples of each wafer type.

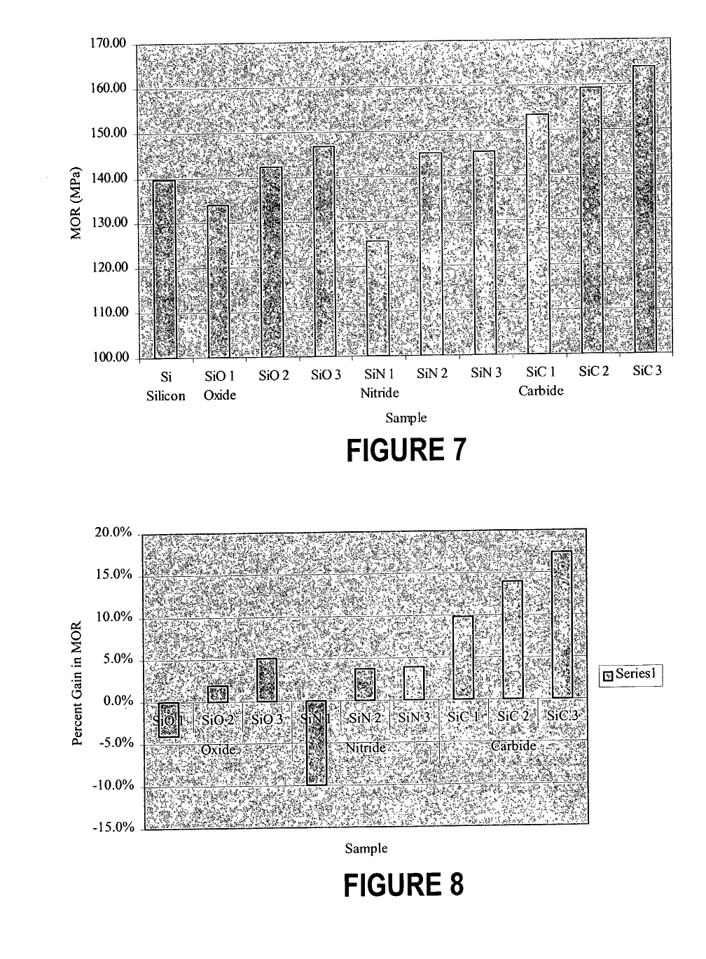

The four-point bending test results of the coated and non-coated samples are shown in FIG. 7. For each of the tested sample types, the MOR was calculated. Referring to FIG. 7, it can be shown that the bare silicon wafer had an average MOR of 139.69 MPa; the SiN-coated samples had an average MOR of 125.7, 144.9, and 145.2 MPa, respectively; the SiO-coated samples had an average MOR of 134.0, 142.4, and 146.8 MPa, respectively; and the SiC-coated samples had an average MOR of 153.4, 159.2, and 164.0 MPa, respectively. The standard deviation for each group will be reported as a percentage of the average value MOR (i.e., standard deviation divided by the average). The values are 18.2% for the silicon samples; 20.7%, 16.6%, and 21.1%, respectively, for the SiN samples; 17.2%, 21.4% and 15.3%, respectively, for the SiO samples; and 20.7%, 22.9% and 17.8%, respectively for the SiC samples. FIG. 8 shows the overall gain in the MOR achieved by coating the wafers, which, in the case of SiC measured as high as 17%. Thus, from FIGS. 6, 7, and 8 it can be seen that the overall mechanical strength of the ceramic coated silicon wafer is greater than the non-coated wafer. It should be noted that of the three compounds discussed above, SiC is the most preferred because it is more resistant to the chemicals used in semiconductor processing and it therefore less likely to be etched away by chemicals used in the various processing steps (e.g., hydrofluoric acid) and yields the greatest increases in mechanical strength. Also, one of ordinary skill in the art having the benefit of this disclosure would recognize that the desired coating need not be absolutely immune from all possible etching and still achieve the desired effect. For example, if a silicon carbide layer that is deposited on the backside of the wafer is originally 5 μm thick, and were 70% of its original thickness (3.5 μm) prior to dicing the wafer, this would still provide adequate strengthening.

Additionally, adequate adhesion of any compound to be used as a coating is important. Adequate layer adhesion is desired so that the coating will survive the fabrication processing steps. Scaling or flaking of the coating, that results from poor adhesion, will be unacceptable since the flaking particles could contaminate other wafers that are being processed, thereby negatively affecting yield. Adhesion properties of proposed coatings may also be characterized by the four-point bending technique described above. Adhesion of the desired material is preferably greater than 100 J/m². Also, a correlation may be drawn between the general adhesion properties and the mechanical strengthening properties. Furthermore, once the wafer is completely processed, but prior to dicing, the coating may be removed in the backgrind step.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A semiconductor wafer having increased mechanical strength properties, wherein said properties are increased by a coating applied to the backside of said wafer.

2. The semiconductor wafer of claim 1, wherein the coating comprises a ceramic coating.

3. The semiconductor wafer of claim 1, wherein the coating is chosen from a list of compounds commonly applied during semiconductor processing, which can withstand temperatures of 1000° C.

4. The semiconductor wafer of claim 1, wherein the coating comprises silicon carbide.

5. The semiconductor wafer of claim 4, wherein the coating has thickness in the range of about 0.5 μm to about 5 μm.

6. The semiconductor wafer of claim 1, wherein the coating is not substantially etched away by fabrication processing.

7. The semiconductor wafer of claim 6, wherein the coating is removed prior to dicing the wafer.

8. The semiconductor wafer of claim 1, wherein the coating is resistant to being etched by hydrofluoric acid.

9. The semiconductor wafer of claim 1, wherein the compound is chosen from the group consisting of silicon dioxide, silicon nitride, and silicon carbide.

10. A method of increasing the mechanical strength of a semiconductor wafer, comprising coating the backside of the semiconductor wafer with a coating.

11. The method of claim 10, wherein said coating has a thickness in the range of about 0.5 μm to about 5 μm.

12. The method of claim 10, wherein said coating comprises a ceramic coating.

13. The method of claim 12, wherein said coating is resistant to being etched by hydrofluoric acid.

14. The method of claim 13, wherein said coating comprises silicon carbide.

15. The method of claim 13, wherein said coating is chosen from the group consisting of silicon dioxide, silicon nitride, and silicon carbide.

16. The method of claim 12, wherein said coating is removed prior to dicing the wafer.

17. The method of claim 16, wherein said removal comprises backgrinding.

18. The method of claim 10, wherein said coating an adhesion of at least 100 J/m².

19. A method for evaluating possible coating materials for semiconductor wafers, comprising:
testing the mechanical strength of non-coated semiconductor wafers;
determining the mechanical strengthening properties of a coating;
applying the coating to a semiconductor wafer; and
testing the mechanical strength of the coated semiconductor wafer.

20. The method of claim 19, wherein the coating is chosen from the group consisting of silicon dioxide, silicon nitride, and silicon carbide.

21. The method of claim 19, wherein the list of acceptable coatings comprises ceramic coatings.

22. The method of claim 21, wherein the coating is not substantially etched away by fabrication processing.

23. The method of claim 22, wherein the coating comprises silicon carbide.

24. The method of claim 19, wherein the coating has an adhesion of at least 100 J/m².

25. The method of claim 19, wherein the mechanical strengthening properties are determined before the application of the coating.
